(19) United States
(12) Patent Application Publication
(10) Pub. No.: US 2025/0224871 A1
(43) Pub. Date: Jul. 10, 2025

(54) ENHANCEMENTS FOR MULTIPLE DATA PLANE READ COMMANDS

(71) Applicant: Micron Technology, Inc., Boise, ID (US)

(72) Inventors: Yutong Lin, Shenzhen (CN); Jing Sang Liu, Shanghai (CN); Peng Fei, Shanghai (CN)

(21) Appl. No.: 18/985,636

(22) Filed: Dec. 18, 2024

Related U.S. Application Data
(60) Provisional application No. 63/617,659, filed on Jan. 4, 2024.

(51) Int. Cl. G06F 3/06

(52) U.S. Cl. CPC G06F 3/0611; G06F 3/0659; G06F 3/0679

(57) ABSTRACT

Methods, systems, and devices for enhancements for multiple data plane read commands are described. In some examples, a memory system may receive a set of multiple read commands and may determine whether a quantity of planes associated with the set of multiple read commands satisfies a threshold. Based on determining that the quantity of planes satisfies a threshold, the memory system may output a multi-plane read command. A memory device may obtain a multi-plane read command and may initiate a first transfer for a first plane based on obtaining the multi-plane read command. The memory device may then generate one or more single-plane commands for one or more planes associated with the multi-plane read command and may initiate a respective data transfer for each of the one or more planes.

### CROSS REFERENCE

The present application for patent claims priority to U.S. Patent Application No. 63/617,659 by Lin et al., entitled “ENHANCEMENTS FOR MULTIPLE DATA PLANE READ COMMANDS,” filed Jan. 4, 2024, which is assigned to the assignee hereof, and which is expressly incorporated by reference in its entirety herein.

### TECHNICAL FIELD

The following relates to one or more systems for memory, including enhancements for multiple data plane read commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports enhancements for multiple data plane read commands in accordance with examples as disclosed herein.

FIG. 2 shows examples of read command configurations that support enhancements for multiple data plane read commands in accordance with examples as disclosed herein.

FIG. 3 shows an example of a process flow that supports enhancements for multiple data plane read commands in accordance with examples as disclosed herein.

FIG. 4 shows an example of a storage structure that supports enhancements for multiple data plane read commands in accordance with examples as disclosed herein.

FIG. 5 shows examples of read command processing configurations that support enhancements for multiple data plane read commands in accordance with examples as disclosed herein.

FIG. 6 shows an example of a process flow that supports enhancements for multiple data plane read commands in accordance with examples as disclosed herein.

FIG. 7 shows a block diagram of a memory system that supports enhancements for multiple data plane read commands in accordance with examples as disclosed herein.

FIG. 8 shows a block diagram of a memory device that supports enhancements for multiple data plane read commands in accordance with examples as disclosed herein.

FIGS. 9 and 10 show flowcharts illustrating a method or methods that support enhancements for multiple data plane read commands in accordance with examples as disclosed herein.

### DETAILED DESCRIPTION

Some systems (e.g., memory systems, memory devices, a solid-state drive (SSD)) may receive (e.g., obtain, process) a relatively large quantity of read commands (e.g., from a host system). The multiple read commands may include sequential read commands as well as random read commands. To support processing of a combination of sequential read commands and random read commands (e.g., to support a random read workload), a system may generate one or more read commands that support accessing (e.g., reading data from) relatively small portions (e.g., 4 kilobytes (KB), 8 KB, 16 KB) of a memory device (e.g., accessing a portion of a page of memory as opposed to accessing the entire page). Such read commands may be referred to as snap read commands. Some snap read commands may be independent word line (IWL) snap read commands (e.g., a single-plane read command, an independent snap read command), which may be associated with accessing a single plane of memory system (e.g., a plane of a die). In some cases, a system may include multiple logical command processors (LCPs) to process one or more generated commands. Each LCP may process a single command (e.g., a single logical command, a single IWL snap read command) at a time. Accordingly, to improve resource utilization efficiency (e.g., LCP utilization, based on a limited quantity of LCPs), the system (e.g., via firmware instructions) may group a set of multiple IWL snap read commands into a combined read command (e.g., a multi-plane read command, a non-IWL snap read command, a combined logical command), which may be associated with accessing multiples planes of a memory system. In such cases, a single LCP may process a single combined read command that accesses multiple planes of memory.

In some cases, however, when processing a multi-plane read command, each plane associated with the multi-plane read command may be inaccessible by other read commands (e.g., non-IWL snap read commands may be incompatible with IWL snap read commands). That is, some planes may be in an idle state while the LCP processes each read command of the multi-plane read command. (e.g., a data transfer for a first plane may be complete, but the first plane may be idle during data transfer for other planes). Accordingly, in some scenarios, combining multiple IWL snap read commands into a multi-plane snap read command may relatively less efficient (e.g., when combining a relatively small quantity of IWL snap read commands). Moreover, because multi-plane read commands may be incompatible with other commands, subsequent read commands (e.g., subsequent IWL snap read commands) may be delayed until the multi-plane read command is fully processed resulting in reduced parallelism of command processing (e.g., reduced bus parallelism). Such effects may reduce a performance (e.g., reduce input/output operations per second (IOPS)) of a memory system, thus decreasing operating speeds and adversely affecting user experience.

In accordance with one or more techniques described herein, a system may support enhanced processing of read commands (e.g., IWL snap read commands, multi-plane read commands) to improve efficiency and processing speed (e.g., increase IOPS) of the memory system. In some examples, the system may determine whether to output (e.g., send, issue, transmit) a IWL snap read command or a multi-plane snap read command based on a comparing a quantity of planes associated with one or more received read commands to a threshold. The system may output a multi-plane read command based on the quantity of planes satisfying the threshold. Otherwise, the system may output individual single-plane read commands (e.g., IWL snap read commands). In some examples, the system may, additionally, or alternatively, support techniques to separate (e.g., parse, process, restructure) a multi-plane read command into multiple single-plane commands (e.g., various commands of different types). For example, the system may process a first logical command of the multi-plane read command, which may generate one or more respective read commands for each respective plane. Additionally, the system may initiate one or more respective data transfer commands for each plane as independent commands (e.g., IWL data transfer commands, a respective data transfer command for each plane), which may enable individual access for (e.g., may unblock) each respective plane associated with a multi-plane read command.

Accordingly, by supporting one or more techniques described herein, a memory system may support increased performance and reduced latency (e.g., improved IOPS). For example, the memory system may be enabled to dynamically determine whether to combine (e.g., group) a set of single-plane snap read commands together, thus enabling the memory system to improve (e.g., optimize, maximize) speed performance under various workloads. Further, by separating a multi-plane read command, the memory system may support enhanced parallelism of command processing by reducing a quantity of idle planes associated with multi-plane read commands.

In addition to applicability in memory systems as described herein, techniques for multi-plane read command enhancements may be generally implemented to support cloud computing and storage applications. As the use of cloud computing to provide processing, storage, and networking services to multiple devices increases, many devices and systems may benefit from improved remote processing and storage capabilities. For example, increasing memory capacity or other capabilities may result in larger and more accessible storage options for users, and increasing memory access times may result in faster processing for computing or database applications. Implementing the techniques described herein may support cloud computing and storages techniques by supporting improved IOPS performance (e.g., of high density memory systems such as system servers, enterprise SSDs, and other devices), supporting relatively higher storage capacities, and providing increased access speeds at cloud servers, resulting in increased response times and decreased processing times, among other benefits.

Features of the disclosure are illustrated and described in the context of systems, devices, and circuits. Features of the disclosure are further illustrated and described in the context of read command configurations, storage structures, process flows, read command processing configurations, and flowcharts.

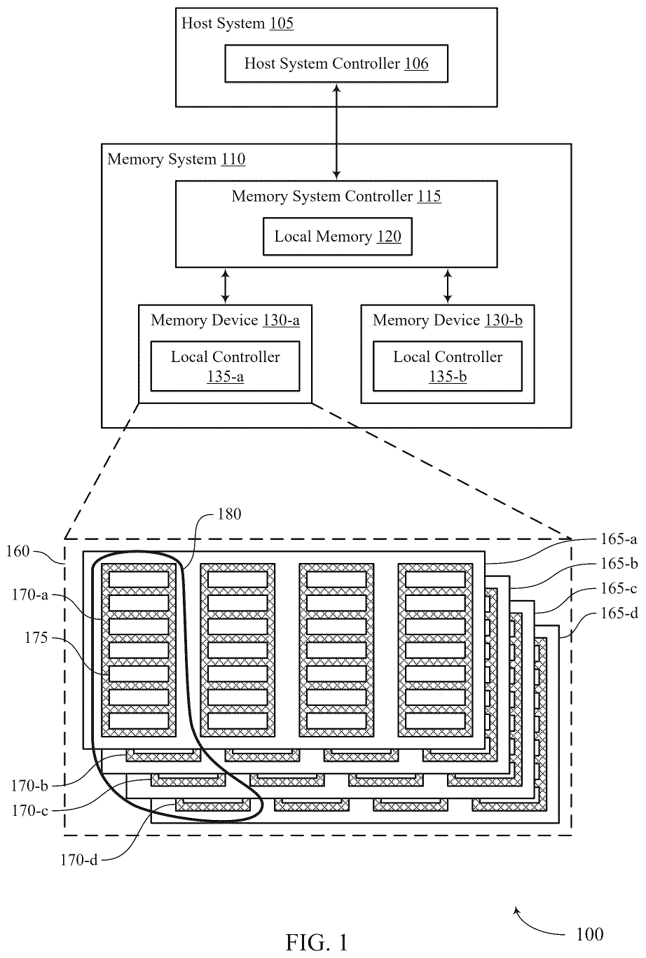

FIG. 1 shows an example of a system 100 that supports enhancements for multiple data plane read commands in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support enhancements for multiple data plane read commands. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, the memory system 110 may receive one or more read commands (e.g., from a host system 105) and may generate one or more corresponding snap read commands (e.g., back-end read commands) to output to a memory device 130. A snap read command may be an IWL snap read command and may be associated with accessing (e.g., reading data from) a single plane 165 of the memory system 110. The memory system 110 may also, in some examples, include a given quantity of LCPs, which may process a single logical command (e.g., a single snap read command) at a time. Accordingly, the memory system 110 may combine (e.g., group, accumulate, associate) a set of multiple single-plane snap read commands into a combined multi-plane read command. However, the multi-plane read command may prohibit subsequent snap read commands for planes 165 associated with the multi-plane read command (e.g., multi-plane read commands may be incompatible with single-plane read commands), thus leaving some planes 165 idle for some durations. Accordingly, in some cases, a multi-plane snap read command may reduce IOPS and overall efficiency of the system 100.

In accordance with one or more techniques described herein, the system 100 may support enhanced processing of read commands (e.g., plane-based read commands). For example, the memory system 110 may determine to output a multi-plane snap read command based on a quantity of planes 165 associated with one or more read commands (e.g., received from the host system 105) satisfying a threshold quantity of planes 165. Additionally, or alternatively, the memory device 130 (e.g., or the memory system 110) may separate (e.g., parse, process, restructure) a multi-plane read command into various portions, including a single logical command to access each plane 165, as well as multiple independent (e.g., IWL) data transfer commands (e.g., a respective command for each plane 165). Accordingly, the devices of the system 100 may, individually or collectively, support improved IOPS for relatively faster response times and reduced latency.

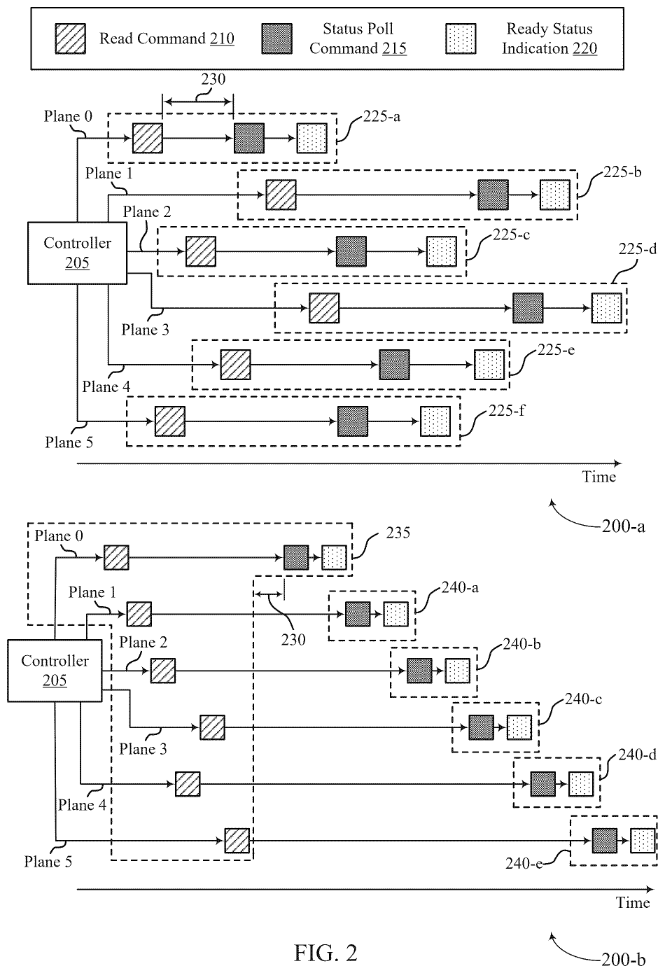

FIG. 2 shows an example of a read command configuration 200-a and a read command configuration 200-b that support enhancements for multiple data plane read commands in accordance with examples as disclosed herein. Each read command configuration 200 may include a controller 205 (e.g., a controller for a ONFI bus, a memory system controller 115), which may be coupled (e.g., communicatively) with one or more planes (e.g., die planes) of a memory device (e.g., a memory device 130, a NAND device). Although, the examples shown in FIG. 2 include six planes (e.g., Plane 0 through Plane 5), the described techniques may apply for any quantity of planes.

In some cases, the controller 205 may output (e.g., transmit, issue, generate) one or more logical commands 225 (e.g., single-plane read commands, IWL commands, a logical command 225-a, a logical command 225-b, a logical command 225-c, a logical command 225-d, a logical command 225-e, a logical command 225-f) for each respective plane (e.g., a first logical command 225-a for Plane 0, a second logical command 225-b for Plane 1, and so on), as shown in the read command configuration 200-a. Additionally, or alternatively, the controller 205 may output a combined logical command 235 (e.g., a multi-plane read command, a non-IWL command) associated with multiple planes (e.g., two or more of Plane 0 through Plane 5), as shown in the read command configuration 200-b. Each of the one or more logical commands 225 and the combined logical command 235 may include one or more read commands 210 (e.g., snap read commands, physical read commands) and one or more status poll commands 215 (e.g., status polling, NAND not ready), which may monitor for one or more respective ready status indications 220 (e.g., status polling to ready). In some cases, the one or more logical commands 225 and the combined logical command 235 may also include one or more data transfer commands, which may occur (e.g., be executed) after identifying a ready status indication 220. A scaling of the time axis for the read command configuration 200-a may not be the same as a scaling of the time axis for the read command configuration 200-b (e.g., the duration 230 of each read command configuration 200 may be a same duration).

In some cases, when a memory system (e.g., a memory system 110) receives one or more random read commands (e.g., when firmware accepts 4 KB/8 KB/16 KB aligned random read commands), the memory system may select an appropriate command type and may output (e.g., transmit, send, issue) a logical command 225 to the controller 205 (e.g., a memory device 130, a local controller 135, an SSD controller) for a target die. Accordingly, the controller 205 may output (e.g., transmit, send, issue) one or more physical commands included (e.g., contained) in the logical command 225 (e.g., on an ONFI bus) to one or more planes (e.g., planes of NAND memory). After waiting for a duration (e.g., a duration 230, a duration quantity, t_READ), the controller 205 may output one or more status polling commands 215 to the target die. When the die returns a ready status (e.g., a ready status indication 220), the controller 205 may initiate (e.g., begin) a data transfer (e.g., using one or more data transfer commands). During the duration 230 and another duration (e.g., interval) for data transfer, some resources of the memory system (e.g., such as an LCP for flash channel) may be occupied by a logical command 225 (e.g., from a beginning to an ending of the logical command 225).

For some read commands (e.g., for 4 KB/8 KB/16B aligned random reads), a memory system may support (e.g., and may biased to use) the read command configuration 200-a (e.g., individual IWL snap read commands for different planes that are handled independently). However, in such cases, one die may support (e.g., handle) a threshold quantity (e.g., six) of IWL snap read commands associated with different planes (e.g., a memory device may process one logical command 225 per plane at a given time). Moreover, the controller 205 may include a limited quantity of LCPs, and each LCP may support a single logical command 225. Further, one flash channel for the controller 205 may include a given quantity of LCPs (e.g., a flash channel may include 16 LCPs) and may be constrained by the quantity of LCPs (e.g., may support a same quantity of logical command 225 as the quantity of LCPs). As such, for relatively large memory systems (e.g., large density SSDs such as 4 terabyte (T) drive), the quantity of LCPs included in the memory system may not be sufficient to support a relatively large quantity of memory dies (e.g., four or more dies, may not support enough LCPs for all planes of each die).

Accordingly, to support an increased quantity of logical commands 225, a controller 205 may combine (e.g., group) several logical commands 225 (e.g., IWL snap read commands) into one logical command 235 (e.g., a combined logical command, a non-IWL multi-plane snap read command). In the case of the combined logical command 235, at least one command for at least one plane may remain as an IWL snap read command. In some cases, the logical command 235 may include one logical command that performs (e.g., generates, executes, issues, transmits, sends) a snap read for all planes (e.g., issues read commands 210 for each of the Planes 0 through 5) as well as a data transfer for at least a first plane (e.g., a first status poll commands 215 followed by a data transfer command for Plane 0). The combined logical command 235 may further perform one or more additional logical commands 240 (e.g., pairs of a status poll commands 215 and ready status indications 220 followed by followed by corresponding data transfer commands, a logical command 240-a, a logical command 240-b, a logical command 240-c, a logical command 240-d, a logical command 240-e) for each remaining plane (e.g., Plane 1 through Plane 5). All commands (e.g., the combined logical command 235 and one or more additional logical commands 240) may be grouped together (e.g., at the controller 205 side) and may occupy (e.g., utilize) a single LCP resource (e.g., commands may be executed serially by an LCP).

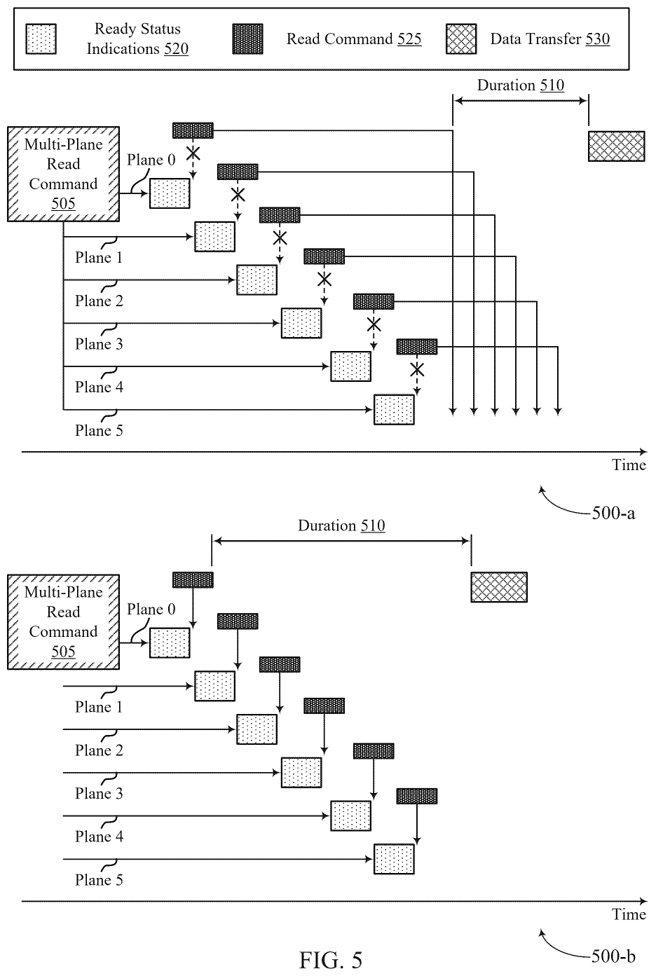

However, a combined logical command 235 (e.g., a non-IWL logical command) and a logical command 225 (e.g., IWL logical command) may be exclusive (e.g., a multi-plane LBA read may conflict with a physical snap read) at a memory device (e.g., in NAND side), and the controller 205 may not be able to identify the physical commands that are included with each logical command (e.g., contained in IWL logical command and non-IWL logical command). Thus, some memory systems may not support concurrent processing of a logical command 225 and a combined logical command 235 for a given plane (e.g., to avoid errors at a memory device). Put another way, some memory systems may not support subsequent logical commands 225 to a target die until all commands (e.g., combined snap read commands) associated with a combined logical command 235 are completed (e.g., as described in greater detail herein including with reference to FIG. 5). Accordingly, free planes (e.g., planes for which all associated commands are completed) may be in an idle state (e.g., after a data transfer for such planes). Thus, in some cases the read command configuration 200-b (e.g., multi-plane snap read case) may be associated with relatively lower efficiency (e.g., lower bus efficiency) as compared to the read command configuration 200-a (e.g., a pure IWL snap read case).

In some cases, a combined logical command 235 that is associated with a relatively smaller quantity of planes (e.g., two) may also share a same duration 230 (e.g., t_READ) as a combined logical command 235 associated with a relatively larger quantity of planes (e.g., six). That is, when processing a combined logical command 235, at least some planes may be in an idle state during the duration 230. Thus, a combined logical command 235 (e.g., a multi-plane snap read command) may support relatively low bus parallelism (e.g., if there are not a sufficient quantity of planes to combine in one multi-plane snap read command). In sum, an IWL snap read performance may be constrained (e.g., limited) by a quantity of LCPs, and a multi-plane snap read performance may be constrained by relatively low bus efficiency (e.g., based on incompatible command types and low bus parallelism). Accordingly, utilizing the read command configuration 200-a, the read command configuration 200-b, or both may not satisfy an operating expectation with respect to IOPS (e.g., for large density SSDs). Thus, enhanced methods to process multi-planes snap read commands may be desired to balance bus parallelism and resources utilization efficiency.

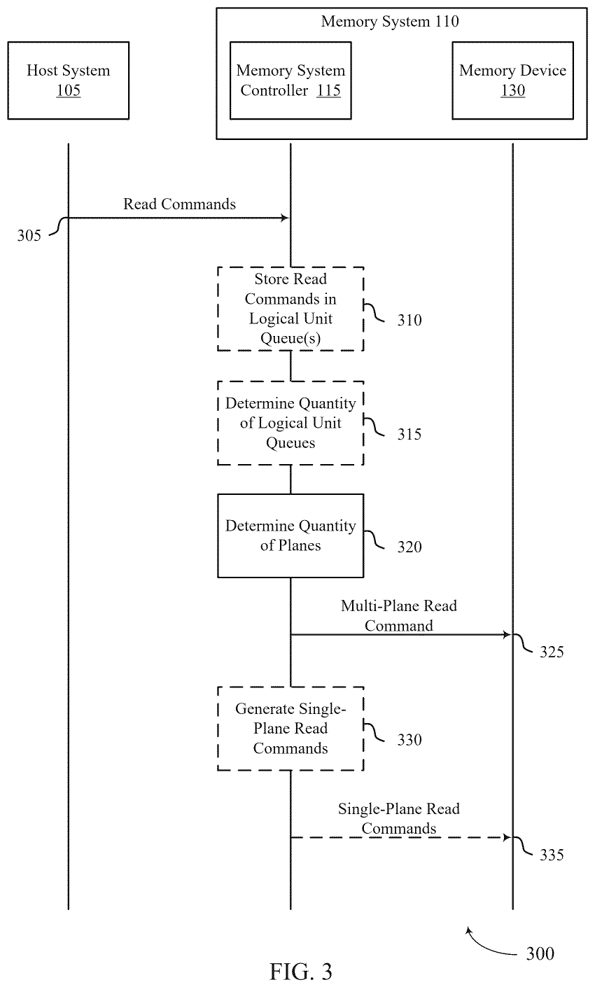

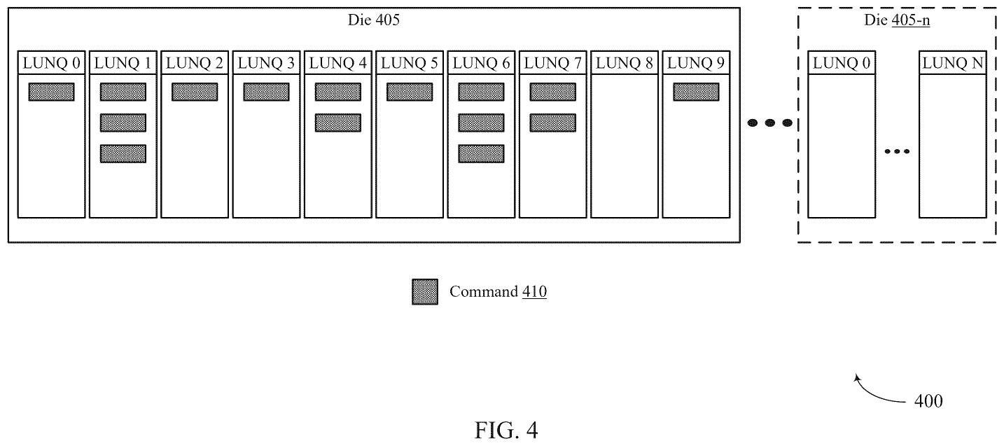

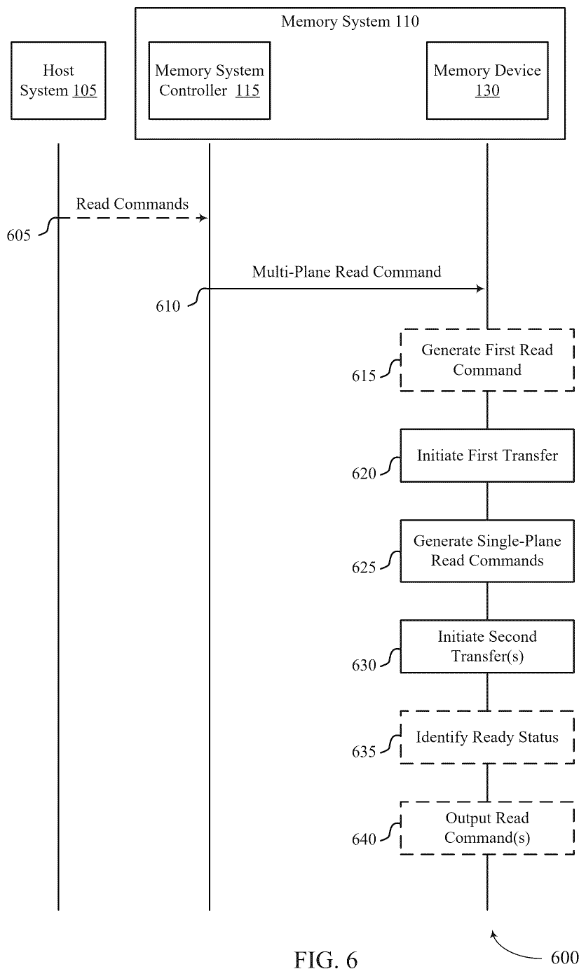

In accordance with one or more techniques described herein, a memory system may support enhanced methods for processing relatively large quantities of read commands (e.g., including a mixture of sequential read commands and random read commands). For example, a memory system may be configured to dynamically generate single-plane read commands (e.g., logical commands 225) or multi-plane read commands (e.g., combined logical commands 235) based on a threshold quantity of planes associated with one or more received IWL snap read commands (e.g., in accordance with a density characteristic of the memory system). Accordingly, a memory system may support more dynamic and more efficient utilization of system resources (e.g., LCPs). Such implementations may be described in greater detail herein including with reference to FIGS. 3 and 4. Additionally, or alternatively, a memory device (e.g., or any component that receives a multi-plane read command) may support an enhanced structure for multi-plane read commands. For example, a memory device may separate an originally combined non-IWL command into one or more non-IWL commands (e.g., an incomplete non-IWL multi-plane snap command) and one or more IWL commands. Accordingly, a memory system may support improved bus efficiency (e.g., improved parallelism). Such implementations may be described in further detail herein including with reference to FIGS. 5 and 6.

FIG. 3 shows an example of a process flow 300 that supports enhancements for multiple data plane read commands in accordance with examples as disclosed herein. In some examples, the process flow 300 may implement aspects of the system 100 and the read command configurations 200. For example, the process flow 300 may support signaling between a host system 105 and a memory system 110, which may include a memory system controller 115 and a memory device 130. The techniques as described with reference to the process flow 300 may enable a memory system 110 to dynamically determine whether to output one or more multi-plane read commands or one or more single-plane read commands.

As described herein, a memory system 110 may be associated with a quantity of LCPs. The memory system 110 may be associated with a relatively high density memory devices 130 (e.g., big density SSDs), and the quantity of LCPs may not support relatively large quantities of read commands associated with the high density memory devices 130. In some cases, multiple read commands (e.g., IWL snap read commands) may be grouped together and processed by a single LCP. However, grouped read commands may be relatively inefficient for some applications.

In accordance with techniques described herein, the memory system 110 may support one or more methods to dynamically select (e.g., generate, determine, identify) a command type (e.g., a read command type, a single-plane snap read type, or a multi-plane snap read type). In some examples, regardless of a quantity of snap read commands, each combined snap read command may share at least a same portion of a processing duration (e.g., a duration 230, t_READ). Accordingly, the command type selection may be based on a quantity of snap read commands (e.g., IWL snap read commands), a quantity of planes associated with a set of multiple read commands (e.g., received from a host system 105), or both (e.g., to allow as many commands as possible to share a same wait duration, t_READ). For example, when the quantity of planes associated with a set of multiple snap read commands satisfies (e.g., meets or exceeds) a threshold quantity the memory system 110 (e.g., via firmware, via the memory system controller 115) may output (e.g., transmit, issue, signal) a multi-plane snap read command. If the quantity of planes fails to satisfy the threshold quantity, the memory system 110 may output one or more single-plane snap read commands. Moreover, the threshold quantity may be based on a density of the memory system 110 (e.g., SSD density, a quantity of dies included in the memory system 110). For instance, the threshold quantities may be defined (e.g., set by firmware) in accordance with Table 1.

TABLE 1

| Density of Memory System | Threshold Value |
|---|---|
| 4T (four dies on a singled ONFI bus) | 5 |
| 8T (eight dies on a single ONFI bus) | 3 |
| 16T (sixteen dies on a single ONFI bus) | 3 |
| 32T (thirty-two dies on a single ONFI bus) | 2 |

Although example values are shown in Table 1, the density values and the threshold values may be different than the values shown (e.g., may be any value, may be dynamically adjusted based on firmware instructions, may be based on other characteristics of the memory system 110). Additionally, in some examples, the one or more snap read commands may be stored in one or more logical unit queues (LUNQs) (e.g., buffers) associated with respective planes. In such examples, the memory system 110 may determine whether a quantity of planes satisfies a threshold based on a quantity of LUNQs used to store the one or more snap read commands. Such implementations may be described in greater detail herein including with reference to FIG. 4.

The following description may describe an example process for dynamically outputting multi-plane read commands based on a threshold quantity of planes associated with one or more read commands. In the process flow 300, the operations between the host system 105, the memory system controller 115, and the memory device 130 may be performed in a different order than the order shown, or other operations may be added or removed from the process flow 300. For example, some operations may also be left out of process flow 300, or may be performed in different orders or at different times. Further, although some operations or signaling may be shown to occur at different times for discussion purposes, these operations may actually occur at the same time. Although the host system 105, the memory system controller 115, and the memory device 130 are shown performing particular operations or signaling in the process flow 300, any of the devices may be configured to perform any of the techniques as described.

At 305, the memory system 110 (e.g., the memory system controller 115) may receive (e.g., the host system 105 may transmit) a set of multiple of read commands. Each read command of the set of read commands may be associated with accessing a respective plane of a memory device (e.g., the set of read commands may be associated with one or more planes). In some examples, the read commands may be sequential read commands, random read commands, or both. For example, at least some of the read commands of the set of read commands may be associated with accessing a sub-portion of a page of a plane.

At 310, in some examples, the memory system 110 (e.g., the memory system controller 115) may store the set of multiple of read commands in one or more LUNQs. In some examples, the memory system 110 may store a respective read command of the set of multiple of read commands in a respective LUNQ of the one or more LUNQs based on a memory die index of the respective read command, a plane index of the respective read command, a command type of the respective read command, or any combination thereof

At 315, in some examples, the memory system 110 (e.g., the memory system controller 115) may determine a quantity of LUNQs that are used to store the set of multiple of read commands. In some examples, the memory system 110 may determine whether the quantity of planes associated with the set of read commands satisfies a threshold based on determining the quantity of LUNQs.

At 320, the memory system 110 (e.g., the memory system controller 115) may determine whether a quantity of planes associated with the set of multiple of read commands satisfies a threshold (e.g., a threshold quantity, a threshold value) based on receiving the set of multiple of read commands. In some examples, the threshold may be based on a quantity of memory dies of the memory system. The memory system 110 may determine that the quantity of planes satisfies (e.g., meets or exceeds) the threshold or that the quantity of planes fails to satisfy the threshold.

At 325, the memory system 110 (e.g., the memory system controller 115) may output (e.g., to a memory device 130) a multi-plane read command to the memory device based on the quantity of planes satisfying the threshold. In some examples, the multi-plane read command may include a logical command (e.g., a logical command 235) that comprises the set of multiple of read commands (e.g., read commands 210) and a set of multiple of data transfer commands (e.g., corresponding to a set of multiple of planes that are associated with the set of multiple read commands).

At 330, in some examples, the memory system 110 (e.g., the memory system controller 115) may generate a set of multiple of single-plane read commands based on a quantity of planes failing to satisfy the threshold. At 335, in such examples, the memory system 110 (e.g., the memory system controller 115) may output (e.g., to the memory device 130) the set of multiple of single-plane read commands. In some examples, each single-plane read command of the set of multiple of single-plane read commands may include a respective read command of the set of multiple of read commands and a data transfer command for the respective plane.

FIG. 4 shows an example of a storage structure 400 that supports enhancements for multiple data plane read commands in accordance with examples as disclosed herein. In some examples, aspects of the storage structure 400 may be implemented by a memory system 110 (e.g., as described with reference to FIGS. 1 through 3). For example, a die 405 may be an example of or include a die 160 (e.g., included in a memory system 110) as described with reference to FIG. 1. The memory system 110 may include one or more dies 405 (e.g., including a quantity of n dies, up to a die 405-n), and each die 405 may include a respective quantity of LUNQs (e.g., buffers). Different dies 405 may include a same quantity of LUNQs or a different quantity of LUNQs with respect to other dies 405.

In some examples, a memory system 110 (e.g., via firmware instructions) may support a flow to process (e.g., handle) one or more commands 410 (e.g., read commands) from a host system. For instance, the memory system 110 may accept one or more read commands (e.g., from a host system) and may retrieve (e.g., fetch, get, read) one or more corresponding physical addresses from a logical-to-physical (L2P) table. The memory system 110 may send (e.g., transmit, output, issue) the one or more read commands to a flash channel (e.g., firmware for flash channel). The flash channel may accept the one or more read commands and may (e.g., temporarily) store (e.g., save) the read commands into one or more LUNQs based on a die index of the read command, a plane index of the read command, a type of read command, or a combination thereof. Subsequently, the flash channel may retrieve (e.g., pop) each command from a LUNQ and may transmit the one or more read commands to a transfer buffer (e.g., XFERQ) of a controller (e.g., memory system controller 115). Accordingly, the control may transmit (e.g., send, output, issue) the one or more read commands to a memory device (e.g., a memory device 130, a NAND device).

Each respective LUNQ (e.g., LUNQ 0 through LUNQ 9) may store commands 410 of a particular command type (e.g., a non-snap host-read command, a write command, a non-host read command, an out of band (OOB) command), commands 410 associated with a particular a plane index (e.g., a snap read command for plane 0, plane 1, plane 2, and so on), a die index (e.g., die 0, die 1, die 2, and so on). For example, LUNQ 0 may store non-snap host read commands, LUNQ 1 may store write commands, LUNQ 2 may store OOB commands, and LUNQ 4 through LUNQ 9 may store snap read commands for Plane 0 through Plane 5 respectively. Thus, the memory system 110 may separate snap read commands for different planes into different LUNQs.

In some examples (e.g., when firmware outputs commands 410 to a controller), the memory system 110 may check how many commands 410 for different planes may be combined to a single multi-plane snap read command. Based on the quantity of planes (e.g., the quantity of LUNQs used to store snap read commands for different planes), the memory system 110 may determine what type of read command (e.g., multi-plane or single-plane) to send to a controller (e.g., a local controller). Accordingly, commands 410 issued to a controller may include both multi-plane read commands and single-plane read commands (e.g., based on a dynamic comparison to a threshold).

In some examples, a memory system 110 may determine a quantity of LUNQs that are used to store one or more snap read commands. For instance, in the example of FIG. 4 LUNQ 4 through LUNQ 9 may be associated with storing snap read commands (e.g., commands 410) for Plane 0 through Plane 5 respectively. The memory system 110 may determine that a quantity of the LUNQs (e.g., five LUNQs) are storing one or more commands 410 (e.g., LUNQ 4, LUNQ 5, LUNQ 6, LUNQ 7, and LUNQ 9). The memory system 110 may determine (e.g., identify, check, ascertain) whether the quantity of LUNQs storing one or more commands 410 satisfy a threshold or fail to satisfy the threshold. In such examples, the memory system 110 may combine the commands 410 into a multi-plane read command based on the quantity of LUNQs satisfying the threshold or may issue the commands 410 as single-plane read commands (e.g., IWL snap read commands) based on the quantity of LUNQs failing to satisfy the threshold.

FIG. 5 shows an example of a read command processing configuration 500-a and a read command processing configuration 500-b that support enhancements for multiple data plane read commands in accordance with examples as disclosed herein. In some examples, components the system 100 may support one or more aspects of the read command processing configuration 500-a and the read command processing configuration 500-b. Each, read command processing configuration 500 may include a multi-plane read command 505 (e.g., a snap read for all combined planes, multi-plane snap read, a non-IWL snap read command), a ready status indication 520 (e.g., following a status poll command 215, status polling to read for each plane) associated with each respective plane, and a read command 525 (e.g., IWL snap read) associated with each respective plane. In some cases, each ready status indication 520 may also initiate (e.g., begin) a data transfer for its respective plane. In the read command processing configuration 500-a, the multi-plane read command 505 may utilize conventional techniques (e.g., may be a grouped non-IWL multi-plane read command, may not support enhanced structures for multi-plane read commands). In comparison, the read command processing configuration 500-b may support one or more techniques described herein that provide enhanced structures and processing of multi-plane read commands 505 (e.g., may support separation of IWL data transfer command for each plane from the multi-plane read command 505).

In the read command processing configuration 500-a, the multi-plane read command 505 may issue a combined logical command (e.g., a logical command 235) for a set of multiple planes (e.g., Plane 0 through Plane 5). However, as described herein, the multi-plane read command 505 may be incompatible other read commands 525 (e.g., with single-plane read commands, IWL snap read commands). In other words, the multi-plane read command 505 may block each plane from receiving a read command 525 (e.g., until each plane reaches a ready status, or issues a ready status indication 520). As such, each read command 525 may occur after a last ready status indication 520 (e.g., of Plane 5, after all read commands of a same die are completed), and a duration 510 (e.g., a transfer duration, a duration 230, t_READ) may begin after a first read command 525 (e.g., of Plane 0) is executed. Thus, some planes may be in an idle state for some durations resulting in reduced bus efficiency (e.g., bus parallelism).

In accordance with one or more techniques described herein, a memory device (e.g., a memory device 130, a local controller 135) may support a read command processing configuration 500-b which may enable a memory device to separate a multi-plane read command 505 (e.g., a grouped multi-plane snap read command) to enhance read performance (e.g., improve random read IOPS) and improve bus efficiency. In some examples, a memory device (e.g., firmware associated with the memory device) may separate an original grouped multi-plane read command 505 by keeping a first logical command as a non-IWL multi-plane command, which may perform a snap read for all planes and a data transfer for a first plane (e.g., Plane 0). Such a separated command may be referred to as a non-IWL non-complete multi-plane snap read command. That is, a multi-plane read command 505 may be separated into one or more IWL snap read commands, one or more IWL data transfer commands, and a non-complete multi-plane snap read command.

Further, one or more remaining commands (e.g., other commands) for data transfer to one or more remaining planes (e.g., other planes) may be set as IWL data transfer commands, which may unblock (e.g., free) each of the planes associated with the multi-plane read command 505 and allow concurrent execution of read commands 525 (e.g., IWL snap read commands in controller side). When the first logical command for all planes read and data transfer for the first plane (e.g., Plane 0) is complete, a subsequent read command 525 (e.g., IWL snap read) for the first plane may be sent to the memory device (e.g., to NAND). After a ready status indication 520 (e.g., based on a respective IWL data transfer command) for a respective plane is complete (e.g., a free plane, a plane that would otherwise remain in an idle status), a subsequent read command 525 for the respective plane may be sent. Accordingly, the memory device may be enabled to process the multi-plane read command 505 and one or more read commands 525 concurrently. That is, one or more read command 525 may occur during a duration 510, which may be a duration between a first read command 525 and a data transfer 530 associated with the first read command (e.g., t_READ may be hidden in an interval for data transfer).

In comparison with read command processing configuration 500-a (e.g., an original multi-plane read command 505), the read command processing configuration 500-b may improve bus efficiency (e.g., bus parallelism) by allowing respective planes associated with a multi-plane read command 505 to receive subsequent IWL snap read commands prior to a completion of the entire multi-plane read command 505. Moreover, a duration during which a multi-plane read command 505 occupies an LCP for IWL data transfer commands may be decreased (e.g., to 4 microseconds as opposed to 50 microseconds) based on monitoring for one or more ready status indications 520 and performing one or more read commands 525 within the duration 510. Moreover, as some non-IWL snap read command may be exclusive with IWL commands for a same die (e.g., on controller side), non-IWL commands may begin after all previous IWL commands for the same die are completed on controller side. Thus, after a non-IWL non-complete multi-plane snap read command completes, IWL data transfer commands may become the first IWL command for target planes. These IWL data transfer commands may also be executed before subsequent IWL snap read commands. As such, data integrity for IWL data transfer commands may be guaranteed.

FIG. 6 shows an example of a process flow 600 that supports enhancements for multiple data plane read commands in accordance with examples as disclosed herein. In some examples, the process flow 600 may implement aspects of the system 100 and the command processing configurations 500. For example, the process flow 600 may support signaling between a host system 105 and a memory system 110, which may include a memory system controller 115 and a memory device 130. The techniques as described with reference to the process flow 600 may enable a memory system 110 to support enhanced processing of multi-plane read commands (e.g., including separating a multi-plane read commands into one or more single-plane read commands).

In the following description of process flow 600, the operations between the host system 105, the memory system controller 115, and the memory device 130 may be performed in a different order than the order shown, or other operations may be added or removed from the process flow 600. For example, some operations may also be left out of process flow 600, or may be performed in different orders or at different times. Further, although some operations or signaling may be shown to occur at different times for discussion purposes, these operations may actually occur at the same time. Although the host system 105, the memory system controller 115, and the memory device 130 are shown performing particular operations or signaling in the process flow 600, any of the host system 105, the memory system controller 115, or the memory device 130 may be configured to perform any of the techniques as described.

At 605, in some examples, a host system 105 may transmit a set of multiple read commands to the memory system 110. The set of read commands may include sequential read commands, random read commands, and other read command types. The memory system 110 may accept the set of read commands and may determine to output a multi-plane read command.

At 610, the memory device 130 may obtain (e.g., the memory system controller 115 may output) one or more multi-plane read commands. A multi-plane read command may include information associated with a set of multiple of read commands (e.g., read commands associated with accessing a set of multiple of planes of the memory device 130) and a set of multiple of data transfer commands corresponding to the set of multiple of planes. In some examples, the information associated with the set of multiple of read commands may include a logical read command that comprises a set of multiple of physical read commands corresponding to the set of multiple of read commands (e.g., a combined logical command 235).

At 615, in some examples, the memory device 130 may generate a first read command for a first plane based on obtaining the multi-plane read command. That is, the memory device 130 may separate the obtained multi-plane read command and may keep a first logical command which may perform snap read for all planes. At 620, the memory device 130 may initiate a transfer (e.g., a first transfer) for a first plane of the set of multiple of planes based on obtaining the multi-plane read command. In some examples, the memory device 130 may initiate the transfer for the first plane is based on generating the first read command.

At 625, the memory device 130 may generate (e.g., separate) a set of multiple of single-plane read commands for one or more remaining planes of the set of multiple of planes based on obtaining the multi-plane read command and initiating the transfer for the first plane. That is, at least some of the commands associated with the multi-plane read command may be set as single-plane commands (e.g., IWL data transfer commands). Accordingly, in some examples, a first LCP of the memory device 130 associated with the first plane may be configured to obtain the multi-plane read command, and a second LCP of the memory device 130 associated with a second plane (e.g., a plane of the one or more remaining planes) of the multi-plane read command may be configured to obtain (e.g., concurrently with the first LCP) a single-plane read command of the set of multiple of single-plane read commands based on generating the set of multiple of single-plane read commands. That is, the memory device 130 may free one or more planes associated with the multi-plane read command based on generating one or more single-plane commands from the multi-plane read command.

At 630, the memory device 130 may initiate a transfer (e.g., a second transfer) for a respective plane (e.g., at least one respective plane) of the one or more remaining planes (e.g., as IWL data transfer commands) based on generating the set of multiple of single-plane read commands. In some examples, initiating the transfer for the respective plane may occur concurrently with a generation of at least on single-plane command (e.g., during a same duration, within a same t_READ).

At 635, in some examples, the memory device 130 may identify a ready status of the first plane based on initiating the transfer for the first plane and may identify a ready status of the respective plane based on initiating the transfer for the respective plane. At 640, in some examples, the memory device 130 may output the first read command based on identifying the ready status of the first plane and may output a single-plane read command of the set of multiple of single-plane read commands for the respective plane based on the identifying the ready status of the respective plane. In some examples, the memory device 130 may further obtain first data associated with the first plane based on initiating the transfer for the first plane. In some examples, initiating the transfer for the respective plane and identifying the ready status of the respective plane may be concurrent with obtaining the first data (e.g., may occur during a same duration).

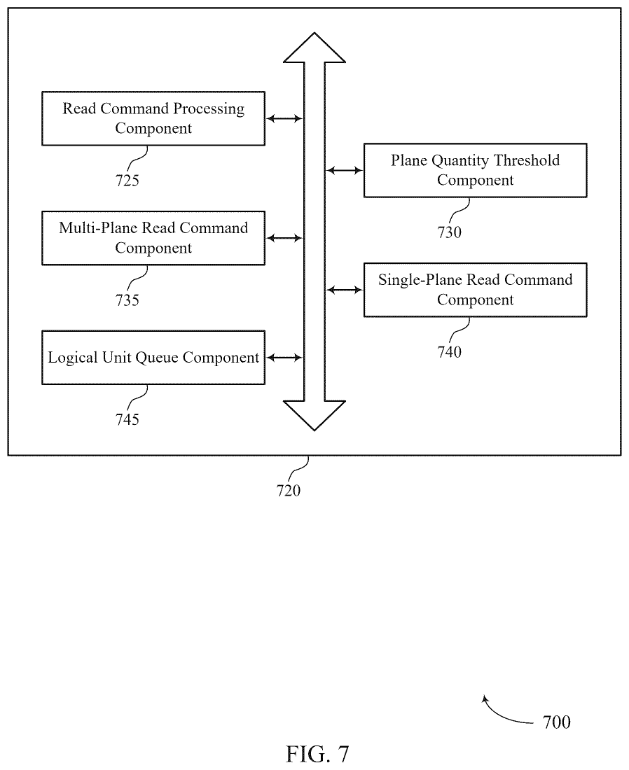

FIG. 7 shows a block diagram 700 of a memory system 720 that supports enhancements for multiple data plane read commands in accordance with examples as disclosed herein. The memory system 720 may be an example of aspects of a memory system as described with reference to FIGS. 1 through 6. The memory system 720, or various components thereof, may be an example of means for performing various aspects of enhancements for multiple data plane read commands as described herein. For example, the memory system 720 may include a read command processing component 725, a plane quantity threshold component 730, a multi-plane read command component 735, a single-plane read command component 740, a LUNQ component 745, or any combination thereof. Each of these components, or components of subcomponents thereof (e.g., one or more processors, one or more memories), may communicate, directly or indirectly, with one another (e.g., via one or more buses).

The read command processing component 725 may be configured as or otherwise support a means for receiving a plurality of read commands each associated with accessing a respective plane of a memory device. The plane quantity threshold component 730 may be configured as or otherwise support a means for determining whether a quantity of planes associated with the plurality of read commands satisfies a threshold based at least in part on receiving the plurality of read commands. The multi-plane read command component 735 may be configured as or otherwise support a means for outputting a multi-plane read command to the memory device based at least in part on the quantity of planes satisfying the threshold, where the multi-plane read command includes a logical command that includes the plurality of read commands and a plurality of data transfer commands corresponding to a plurality of planes.

In some examples, the read command processing component 725 may be configured as or otherwise support a means for receiving a second plurality of read commands. In some examples, the plane quantity threshold component 730 may be configured as or otherwise support a means for determining that a second quantity of planes associated with the second plurality of read commands fails to satisfy the threshold. In some examples, the single-plane read command component 740 may be configured as or otherwise support a means for generating a plurality of single-plane read commands based at least in part on the second quantity of planes failing to satisfy the threshold. In some examples, the single-plane read command component 740 may be configured as or otherwise support a means for outputting the plurality of single-plane read commands.

In some examples, each single-plane read command of the plurality of single-plane read commands includes a respective read command of the plurality of read commands and a data transfer command for the respective plane.

In some examples, the threshold is based at least in part on a quantity of memory dies of the memory system.

In some examples, the LUNQ component 745 may be configured as or otherwise support a means for storing the plurality of read commands in one or more LUNQs. In some examples, the plane quantity threshold component 730 may be configured as or otherwise support a means for determining a quantity of LUNQs that are used to store the plurality of read commands, where determining whether the quantity of planes satisfies the threshold is based at least in part on determining the quantity of LUNQs.

In some examples, to support storing the plurality of read commands, the LUNQ component 745 may be configured as or otherwise support a means for storing a respective read command of the plurality of read commands in a respective LUNQ of the one or more LUNQs based at least in part on a memory die index of the respective read command, a plane index of the respective read command, a command type of the respective read command, or any combination thereof.

In some examples, one or more read commands of the plurality of read commands are associated with accessing a sub-portion of a page of a plane.

In some examples, the described functionality of the memory system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 720, or various components thereof, may be implemented at least in part by instructions (e.g., stored in memory, non-transitory computer-readable medium) executable by such at least one processor.

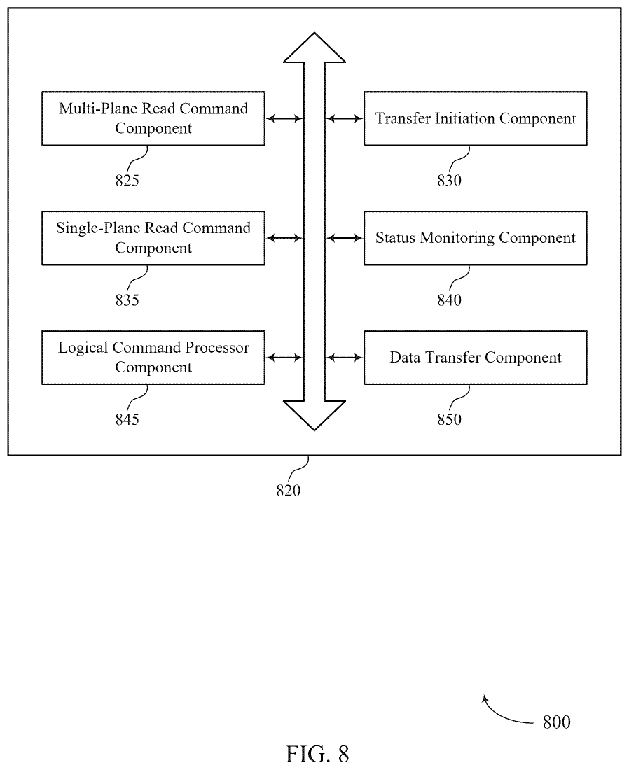

FIG. 8 shows a block diagram 800 of a memory device 820 that supports enhancements for multiple data plane read commands in accordance with examples as disclosed herein. The memory device 820 may be an example of aspects of a memory device as described with reference to FIGS. 1 through 6. In some examples, the memory device 820 may be included as part of a memory system 720 as described with reference to FIG. 7. The memory device 820, or various components thereof, may be an example of means for performing various aspects of enhancements for multiple data plane read commands as described herein. For example, the memory device 820 may include a multi-plane read command component 825, a transfer initiation component 830, a single-plane read command component 835, a status monitoring component 840, a logical command processor component 845, a data transfer component 850, or any combination thereof. Each of these components, or components of subcomponents thereof (e.g., one or more processors, one or more memories), may communicate, directly or indirectly, with one another (e.g., via one or more buses).

The multi-plane read command component 825 may be configured as or otherwise support a means for obtaining a multi-plane read command including information associated with a plurality of read commands for accessing a plurality of planes of the memory device and a plurality of data transfer commands corresponding to the plurality of planes. The transfer initiation component 830 may be configured as or otherwise support a means for initiating a transfer for a first plane of the plurality of planes based at least in part on obtaining the multi-plane read command. The single-plane read command component 835 may be configured as or otherwise support a means for generating a plurality of single-plane read commands for one or more remaining planes of the plurality of planes based at least in part on obtaining the multi-plane read command and initiating the transfer for the first plane. In some examples, the transfer initiation component 830 may be configured as or otherwise support a means for initiating a transfer for a respective plane of the one or more remaining planes based at least in part on generating the plurality of single-plane read commands.

In some examples, the multi-plane read command component 825 may be configured as or otherwise support a means for generating a first read command for the first plane based at least in part on obtaining the multi-plane read command, where initiating the transfer for the first plane is based at least in part on generating the first read command.

In some examples, the status monitoring component 840 may be configured as or otherwise support a means for identifying a ready status of the first plane based at least in part on initiating the transfer for the first plane. In some examples, the single-plane read command component 835 may be configured as or otherwise support a means for outputting the first read command based at least in part on identifying the ready status of the first plane.

In some examples, the status monitoring component 840 may be configured as or otherwise support a means for identifying a ready status of the respective plane based at least in part on initiating the transfer for the respective plane. In some examples, the single-plane read command component 835 may be configured as or otherwise support a means for outputting a single-plane read command of the plurality of single-plane read commands for the respective plane based at least in part on identifying the ready status of the respective plane.

In some examples, the data transfer component 850 may be configured as or otherwise support a means for obtaining first data associated with the first plane based at least in part on initiating the transfer for the first plane, where initiating the transfer for the respective plane and identifying the ready status of the respective plane are concurrent with obtaining the first data.

In some examples, a first logical command processor of the memory device associated with the first plane is configured to obtain the multi-plane read command. In some examples, a second logical command processor of the memory device associated with the respective plane is configured to obtain a single-plane read command of the plurality of single-plane read commands based at least in part on generating the plurality of single-plane read commands.

In some examples, the information associated with the plurality of read commands includes a logical read command that includes a plurality of physical read commands corresponding to the plurality of read commands.

In some examples, the described functionality of the memory device 820, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory device 820, or various components thereof, may be implemented at least in part by instructions (e.g., stored in memory, non-transitory computer-readable medium) executable by such at least one processor.

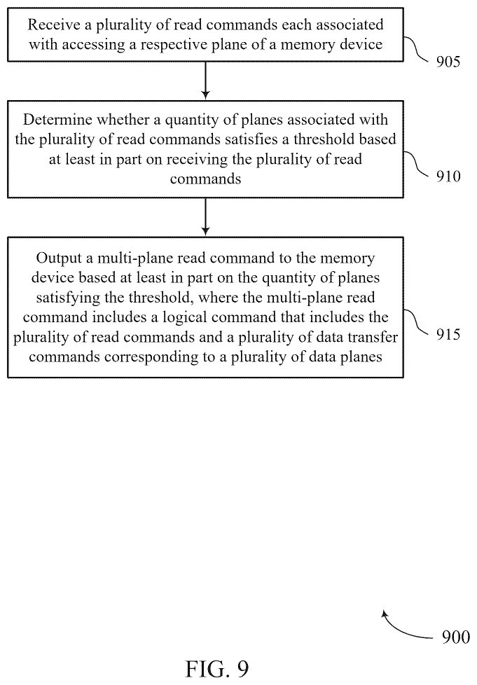

FIG. 9 shows a flowchart illustrating a method 900 that supports enhancements for multiple data plane read commands in accordance with examples as disclosed herein. The operations of method 900 may be implemented by a memory system or its components as described herein. For example, the operations of method 900 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 905, the method may include receiving a plurality of read commands each associated with accessing a respective plane of a memory device. In some examples, aspects of the operations of 905 may be performed by a read command processing component 725 as described with reference to FIG. 7.

At 910, the method may include determining whether a quantity of planes associated with the plurality of read commands satisfies a threshold based at least in part on receiving the plurality of read commands. In some examples, aspects of the operations of 910 may be performed by a plane quantity threshold component 730 as described with reference to FIG. 7.

At 915, the method may include outputting a multi-plane read command to the memory device based at least in part on the quantity of planes satisfying the threshold, where the multi-plane read command includes a logical command that includes the plurality of read commands and a plurality of data transfer commands corresponding to a plurality of planes. In some examples, aspects of the operations of 915 may be performed by a multi-plane read command component 735 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a plurality of read commands each associated with accessing a respective plane of a memory device; determining whether a quantity of planes associated with the plurality of read commands satisfies a threshold based at least in part on receiving the plurality of read commands; and outputting a multi-plane read command to the memory device based at least in part on the quantity of planes satisfying the threshold, where the multi-plane read command includes a logical command that includes the plurality of read commands and a plurality of data transfer commands corresponding to a plurality of planes.

Aspect 2: The method, apparatus, or non-transitory computer-readable medium of aspect 1, further including operations, features, circuitry, logic, means, or instructions, or any combination thereof for receiving a second plurality of read commands; determining that a second quantity of planes associated with the second plurality of read commands fails to satisfy the threshold; generating a plurality of single-plane read commands based at least in part on the second quantity of planes failing to satisfy the threshold; and outputting the plurality of single-plane read commands.

Aspect 3: The method, apparatus, or non-transitory computer-readable medium of aspect 2, where each single-plane read command of the plurality of single-plane read commands includes a respective read command of the plurality of read commands and a data transfer command for the respective plane.

Aspect 4: The method, apparatus, or non-transitory computer-readable medium of any of aspects 1 through 3, where the threshold is based at least in part on a quantity of memory dies of the memory system.

Aspect 5: The method, apparatus, or non-transitory computer-readable medium of any of aspects 1 through 4, further including operations, features, circuitry, logic, means, or instructions, or any combination thereof for storing the plurality of read commands in one or more LUNQs and determining a quantity of LUNQs that are used to store the plurality of read commands, where determining whether the quantity of planes satisfies the threshold is based at least in part on determining the quantity of LUNQs.

Aspect 6: The method, apparatus, or non-transitory computer-readable medium of aspect 5, where storing the plurality of read commands includes operations, features, circuitry, logic, means, or instructions, or any combination thereof for storing a respective read command of the plurality of read commands in a respective LUNQ of the one or more LUNQs based at least in part on a memory die index of the respective read command, a plane index of the respective read command, a command type of the respective read command, or any combination thereof.

Aspect 7: The method, apparatus, or non-transitory computer-readable medium of any of aspects 1 through 6, where one or more read commands of the plurality of read commands are associated with accessing a sub-portion of a page of a plane.

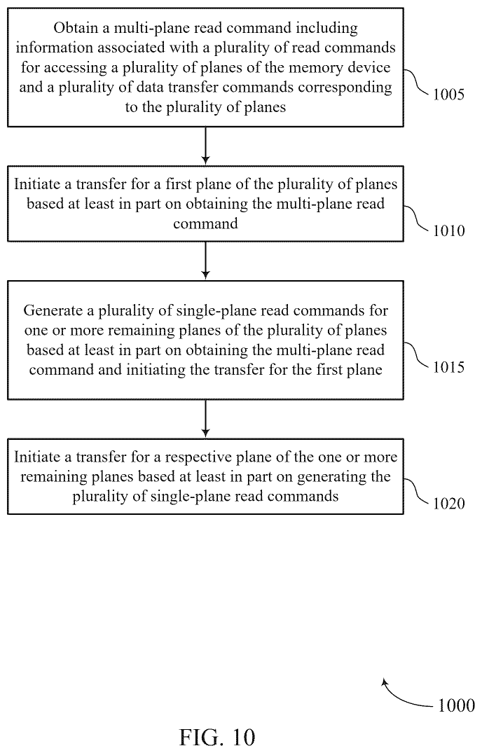

FIG. 10 shows a flowchart illustrating a method 1000 that supports enhancements for multiple data plane read commands in accordance with examples as disclosed herein. The operations of method 1000 may be implemented by a memory device or its components as described herein. For example, the operations of method 1000 may be performed by a memory device as described with reference to FIGS. 1 through 6 and 8. In some examples, a memory device may execute a set of instructions to control the functional elements of the device to perform the described functions. Additionally, or alternatively, the memory device may perform aspects of the described functions using special-purpose hardware.

At 1005, the method may include obtaining a multi-plane read command including information associated with a plurality of read commands for accessing a plurality of planes of the memory device and a plurality of data transfer commands corresponding to the plurality of planes. In some examples, aspects of the operations of 1005 may be performed by a multi-plane read command component 825 as described with reference to FIG. 8.

At 1010, the method may include initiating a transfer for a first plane of the plurality of planes based at least in part on obtaining the multi-plane read command. In some examples, aspects of the operations of 1010 may be performed by a transfer initiation component 830 as described with reference to FIG. 8.

At 1015, the method may include generating a plurality of single-plane read commands for one or more remaining planes of the plurality of planes based at least in part on obtaining the multi-plane read command and initiating the transfer for the first plane. In some examples, aspects of the operations of 1015 may be performed by a single-plane read command component 835 as described with reference to FIG. 8.

At 1020, the method may include initiating a transfer for a respective plane of the one or more remaining planes based at least in part on generating the plurality of single-plane read commands. In some examples, aspects of the operations of 1020 may be performed by a transfer initiation component 830 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 8: A method, apparatus, or non-transitory computer-readable medium including operations, features, circuitry, logic, means, or instructions, or any combination thereof for obtaining a multi-plane read command including information associated with a plurality of read commands for accessing a plurality of planes of the memory device and a plurality of data transfer commands corresponding to the plurality of planes; initiating a transfer for a first plane of the plurality of planes based at least in part on obtaining the multi-plane read command; generating a plurality of single-plane read commands for one or more remaining planes of the plurality of planes based at least in part on obtaining the multi-plane read command and initiating the transfer for the first plane; and initiating a transfer for a respective plane of the one or more remaining planes based at least in part on generating the plurality of single-plane read commands.

Aspect 9: The method, apparatus, or non-transitory computer-readable medium of aspect 8, further including operations, features, circuitry, logic, means, or instructions, or any combination thereof for generating a first read command for the first plane based at least in part on obtaining the multi-plane read command, where initiating the transfer for the first plane is based at least in part on generating the first read command.

Aspect 10: The method, apparatus, or non-transitory computer-readable medium of aspect 9, further including operations, features, circuitry, logic, means, or instructions, or any combination thereof for identifying a ready status of the first plane based at least in part on initiating the transfer for the first plane and outputting the first read command based at least in part on identifying the ready status of the first plane.

Aspect 11: The method, apparatus, or non-transitory computer-readable medium of any of aspects 8 through 10, further including operations, features, circuitry, logic, means, or instructions, or any combination thereof for identifying a ready status of the respective plane based at least in part on initiating the transfer for the respective plane and outputting a single-plane read command of the plurality of single-plane read commands for the respective plane based at least in part on identifying the ready status of the respective plane.

Aspect 12: The method, apparatus, or non-transitory computer-readable medium of aspect 11, further including operations, features, circuitry, logic, means, or instructions, or any combination thereof for obtaining first data associated with the first plane based at least in part on initiating the transfer for the first plane, where initiating the transfer for the respective plane and identifying the ready status of the respective plane are concurrent with obtaining the first data.

Aspect 13: The method, apparatus, or non-transitory computer-readable medium of any of aspects 8 through 12, where a first logical command processor of the memory device associated with the first plane is configured to obtain the multi-plane read command and a second logical command processor of the memory device associated with the respective plane is configured to obtain a single-plane read command of the plurality of single-plane read commands based at least in part on generating the plurality of single-plane read commands.

Aspect 14: The method, apparatus, or non-transitory computer-readable medium of any of aspects 8 through 13, where the information associated with the plurality of read commands includes a logical read command that includes a plurality of physical read commands corresponding to the plurality of read commands.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

As used herein, the term “substantially” means that the modified characteristic (e.g., a verb or adjective modified by the term substantially) need not be absolute but is close enough to achieve the advantages of the characteristic.

As used herein, the term “electrode” may refer to an electrical conductor, and in some examples, may be employed as an electrical contact to a memory cell or other component of a memory array. An electrode may include a trace, wire, conductive line, conductive layer, or the like that provides a conductive path between elements or components of a memory array.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
receiving a plurality of read commands each associated with accessing a respective plane of a memory device;
determining whether a quantity of planes associated with the plurality of read commands satisfies a threshold based at least in part on receiving the plurality of read commands; and
outputting a multi-plane read command to the memory device based at least in part on the quantity of planes satisfying the threshold, wherein the multi-plane read command comprises a logical command that comprises the plurality of read commands and a plurality of data transfer commands corresponding to a plurality of planes.

2. The method of claim 1, further comprising:
receiving a second plurality of read commands;
determining that a second quantity of planes associated with the second plurality of read commands fails to satisfy the threshold;
generating a plurality of single-plane read commands based at least in part on the second quantity of planes failing to satisfy the threshold; and
outputting the plurality of single-plane read commands.

3. The method of claim 2, wherein each single-plane read command of the plurality of single-plane read commands comprises a respective read command of the plurality of read commands and a data transfer command for the respective plane.

4. The method of claim 1, wherein the threshold is based at least in part on a quantity of memory dies of the memory system.

5. The method of claim 1, further comprising:
storing the plurality of read commands in one or more logical unit queues; and
determining a quantity of logical unit queues that are used to store the plurality of read commands, wherein determining whether the quantity of planes satisfies the threshold is based at least in part on determining the quantity of logical unit queues.

6. The method of claim 5, wherein storing the plurality of read commands comprises:
storing a respective read command of the plurality of read commands in a respective logical unit queue of the one or more logical unit queues based at least in part on a memory die index of the respective read command, a plane index of the respective read command, a command type of the respective read command, or any combination thereof.

7. The method of claim 1, wherein one or more read commands of the plurality of read commands are associated with accessing a sub-portion of a page of a plane.

8. A method by a memory device, comprising:
obtaining a multi-plane read command comprising information associated with a plurality of read commands for accessing a plurality of planes of the memory device and a plurality of data transfer commands corresponding to the plurality of planes;
initiating a transfer for a first plane of the plurality of planes based at least in part on obtaining the multi-plane read command;
generating a plurality of single-plane read commands for one or more remaining planes of the plurality of planes based at least in part on obtaining the multi-plane read command and initiating the transfer for the first plane; and
initiating a transfer for a respective plane of the one or more remaining planes based at least in part on generating the plurality of single-plane read commands.

9. The method of claim 8, further comprising:
generating a first read command for the first plane based at least in part on obtaining the multi-plane read command, wherein initiating the transfer for the first plane is based at least in part on generating the first read command.

10. The method of claim 9, further comprising:
identifying a ready status of the first plane based at least in part on initiating the transfer for the first plane; and
outputting the first read command based at least in part on identifying the ready status of the first plane.

11. The method of claim 8, further comprising:
identifying a ready status of the respective plane based at least in part on initiating the transfer for the respective plane; and
outputting a single-plane read command of the plurality of single-plane read commands for the respective plane based at least in part on identifying the ready status of the respective plane.

12. The method of claim 11, further comprising:
obtaining first data associated with the first plane based at least in part on initiating the transfer for the first plane, wherein initiating the transfer for the respective plane and identifying the ready status of the respective plane are concurrent with obtaining the first data.

13. The method of claim 8, wherein:
a first logical command processor of the memory device associated with the first plane is configured to obtain the multi-plane read command; and
a second logical command processor of the memory device associated with the respective plane is configured to obtain a single-plane read command of the plurality of single-plane read commands based at least in part on generating the plurality of single-plane read commands.

14. The method of claim 8, wherein the information associated with the plurality of read commands comprises a logical read command that comprises a plurality of physical read commands corresponding to the plurality of read commands.

15. A non-transitory computer-readable medium storing code, the code comprising instructions executable by one or more processors to:
receive a plurality of read commands each associated with accessing a respective plane of a memory device;
determine whether a quantity of planes associated with the plurality of read commands satisfies a threshold based at least in part on receiving the plurality of read commands; and
output a multi-plane read command to the memory device based at least in part on the quantity of planes satisfying the threshold, wherein the multi-plane read command comprises a logical command that comprises the plurality of read commands and a plurality of data transfer commands corresponding to a plurality of planes.

16. The non-transitory computer-readable medium of claim 15, wherein the instructions are further executable by the one or more processors to:
receive a second plurality of read commands;
determine that a second quantity of planes associated with the second plurality of read commands fails to satisfy the threshold;
generate a plurality of single-plane read commands based at least in part on the second quantity of planes failing to satisfy the threshold; and
output the plurality of single-plane read commands.

17. The non-transitory computer-readable medium of claim 16, wherein each single-plane read command of the plurality of single-plane read commands comprises a respective read command of the plurality of read commands and a data transfer command for the respective plane.

18. The non-transitory computer-readable medium of claim 15, wherein the threshold is based at least in part on a quantity of memory dies of a memory system.

19. The non-transitory computer-readable medium of claim 15, wherein the instructions are further executable by the one or more processors to:
store the plurality of read commands in one or more logical unit queues; and
determine a quantity of logical unit queues that are used to store the plurality of read commands, wherein determining whether the quantity of planes satisfies the threshold is based at least in part on determining the quantity of logical unit queues.

20. The non-transitory computer-readable medium of claim 19, wherein the instructions to store the plurality of read commands are executable by the one or more processors to:
store a respective read command of the plurality of read commands in a respective logical unit queue of the one or more logical unit queues based at least in part on a memory die index of the respective read command, a plane index of the respective read command, a command type of the respective read command, or any combination thereof.

21. The non-transitory computer-readable medium of claim 15, wherein one or more read commands of the plurality of read commands are associated with accessing a sub-portion of a page of a plane.

22. A memory system, comprising:
one or more memory devices; and
processing circuitry coupled with the one or more memory devices and configured to cause the memory system to:
receive a plurality of read commands each associated with accessing a respective plane of a memory device;
determine whether a quantity of planes associated with the plurality of read commands satisfies a threshold based at least in part on receiving the plurality of read commands; and
output a multi-plane read command to the memory device based at least in part on the quantity of planes satisfying the threshold, wherein the multi-plane read command comprises a logical command that comprises the plurality of read commands and a plurality of data transfer commands corresponding to a plurality of planes.

23. The memory system of claim 22, wherein the processing circuitry is further configured to cause the memory system to:
receive a second plurality of read commands;
determine that a second quantity of planes associated with the second plurality of read commands fails to satisfy the threshold;
generate a plurality of single-plane read commands based at least in part on the second quantity of planes failing to satisfy the threshold; and
output the plurality of single-plane read commands.

24. The memory system of claim 23, wherein each single-plane read command of the plurality of single-plane read commands comprises a respective read command of the plurality of read commands and a data transfer command for the respective plane.

25. The memory system of claim 22, wherein the threshold is based at least in part on a quantity of memory dies of the memory system.

26. The memory system of claim 22, wherein the processing circuitry is further configured to cause the memory system to:
store the plurality of read commands in one or more logical unit queues; and
determine a quantity of logical unit queues that are used to store the plurality of read commands, wherein determining whether the quantity of planes satisfies the threshold is based at least in part on determining the quantity of logical unit queues.

27. The memory system of claim 26, wherein storing the plurality of read commands comprises the processing circuitry configured to cause the memory system to:
store a respective read command of the plurality of read commands in a respective logical unit queue of the one or more logical unit queues based at least in part on a memory die index of the respective read command, a plane index of the respective read command, a command type of the respective read command, or any combination thereof.

28. The memory system of claim 22, wherein one or more read commands of the plurality of read commands are associated with accessing a sub-portion of a page of a plane.

29. A memory device, comprising:
one or more memory arrays; and
processing circuitry coupled with the one or more memory arrays and configured to cause the memory device to:
obtain a multi-plane read command comprising information associated with a plurality of read commands for accessing a plurality of planes of the memory device and a plurality of data transfer commands corresponding to the plurality of planes;
initiate a transfer for a first plane of the plurality of planes based at least in part on obtaining the multi-plane read command;
generate a plurality of single-plane read commands for one or more remaining planes of the plurality of planes based at least in part on obtaining the multi-plane read command and initiating the transfer for the first plane; and
initiate a transfer for a respective plane of the one or more remaining planes based at least in part on generating the plurality of single-plane read commands.

30. The memory device of claim 29, wherein the processing circuitry is further configured to cause the memory device to:
generate a first read command for the first plane based at least in part on obtaining the multi-plane read command, wherein initiating the transfer for the first plane is based at least in part on generating the first read command.

31. The memory device of claim 30, wherein the processing circuitry is further configured to cause the memory device to:
identify a ready status of the first plane based at least in part on initiating the transfer for the first plane; and
output the first read command based at least in part on identifying the ready status of the first plane.

32. The memory device of claim 29, wherein the processing circuitry is further configured to cause the memory device to:
identify a ready status of the respective plane based at least in part on initiating the transfer for the respective plane; and
output a single-plane read command of the plurality of single-plane read commands for the respective plane based at least in part on identifying the ready status of the respective plane.

33. The memory device of claim 32, wherein the processing circuitry is further configured to cause the memory device to:
obtain first data associated with the first plane based at least in part on initiating the transfer for the first plane, wherein initiating the transfer for the respective plane and identifying the ready status of the respective plane are concurrent with obtaining the first data.

34. The memory device of claim 29, wherein:
a first logical command processor of the memory device associated with the first plane is configured to obtain the multi-plane read command; and
a second logical command processor of the memory device associated with the respective plane is configured to obtain a single-plane read command of the plurality of single-plane read commands based at least in part on generating the plurality of single-plane read commands.

35. The memory device of claim 29, wherein the information associated with the plurality of read commands comprises a logical read command that comprises a plurality of physical read commands corresponding to the plurality of read commands.
